(19) United States
(12) Patent Application Publication
(10) Pub. No.: US 2016/0203404 A1
(43) Pub. Date: Jul. 14, 2016

(54) PREDICTING EXECUTION TIMES OF CONCURRENT QUERIES

(71) Applicant: HEWLETT PACKARD ENTERPRISE DEVELOPMENT LP, Houston, TX (US)

(72) Inventors: Ludmila Cherkasova, Sunnyvale, CA (US); Chetan Kumar Gupta, San Mateo, CA (US); Alkiviadis Simitsis, Santa Clara, CA (US); Jianqiang Wang, Palo Alto, CA (US); William K. Wilkinson, San Mateo, CA (US)

(21) Appl. No.: 14/917,074

(22) PCT Filed: Sep. 14, 2013
(86) PCT No.: PCT/US2013/059837

§ 371 Date: Mar. 7, 2016

(51) Int. Cl. G06N 5/04; G06N 99/00

(52) U.S. Cl. CPC G06N 5/04; G06N 99/005

(57) ABSTRACT

Example embodiments relate to predicting execution times of concurrent queries. In example embodiments, historical data is iteratively generated for a machine learning model by varying a concurrency level of query executions in a database, determining a query execution plan for a pending concurrent query, extracting query features from the query execution plan, and executing the pending concurrent query to determine a query execution time. The machine learning model may then be created based on the query features, variation in the concurrency level, and the query execution time. The machine learning model is used to generate an execution schedule for production queries, where the execution schedule satisfies service level agreements of the production queries.

### BACKGROUND

For meeting service level agreements (SLAs) and efficient workload processing in database management systems (DBMS), system administrators seek to control query admission and enforce efficient query scheduling. The ability to accurately predict query completion times allows system administrators to implement effective workload management in the DBMS. When executing concurrent queries, current optimization techniques aim (1) to design a tailored schedule for executing multiple queries in the set that minimize the entire set's completion time or (2) to tune multiprogramming level (MPL) settings (i.e., the number of concurrently executing queries) for optimized query executions. Typically, these optimization techniques empirically study the mutual interactions of concurrent queries.

### BRIEF DESCRIPTION OF THE DRAWINGS

The drawing detailed description references the drawings, wherein:

FIG. 1 is a block diagram of an example computing device for predicting execution times of concurrent queries;

FIG. 2 is a block diagram of an example computing device in communication with a database for predicting execution times of concurrent queries;

FIG. 3 is a flowchart of an example method for execution by a computing device for predicting execution times of concurrent queries;

FIG. 4 is a flowchart of an example method for execution by a computing device for generating historic data and then predicting execution times of concurrent queries in production;

FIG. 5 is a flowchart of an example workflow for creating a machine learning model for predicting execution times of concurrent queries; and

FIG. 6 is a diagram of an example query execution plan.

### DETAILED DESCRIPTION

As detailed above, current optimization techniques aim to minimize the total completion time of a set of concurrent queries or to tune MPL settings for optimized query executions. These techniques do not attempt to predict the query completion time of individual queries in the set of concurrent queries. Techniques that do predict query execution time are typically based on measurements of a query executed in isolation. However, the presence of concurrent queries that compete for shared resources can significantly impact the query execution time compared to the completion time of the query run in isolation.

Example embodiments disclosed herein provide predicting execution times of concurrent queries. For example, in some embodiments, historical data is iteratively generated for a machine learning model by varying a concurrency level of query executions in a database, determining a query execution plan for a pending concurrent query, extracting query features from the query execution plan, and executing the pending concurrent query to determine a query execution time. The machine learning model may then be created based on the query features, variation in the concurrency level, and the query execution time. The machine learning model is used to generate an execution schedule for production queries, where the execution schedule satisfies service level agreements of the production queries.

In this manner, example embodiments disclosed herein improve predicting execution times of concurrent queries by using a machine learning model that is derived from monitoring training queries executed at varying concurrency levels. Specifically, the machine learning model is generated based on historic data that includes query features extracted from query execution plans and associated execution times at varying concurrency levels.

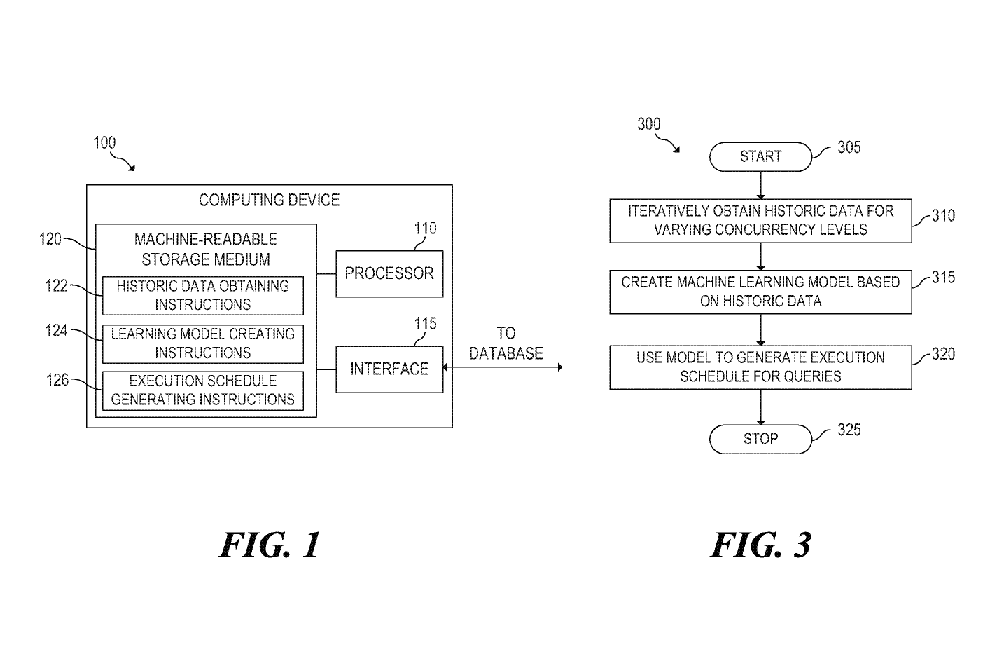

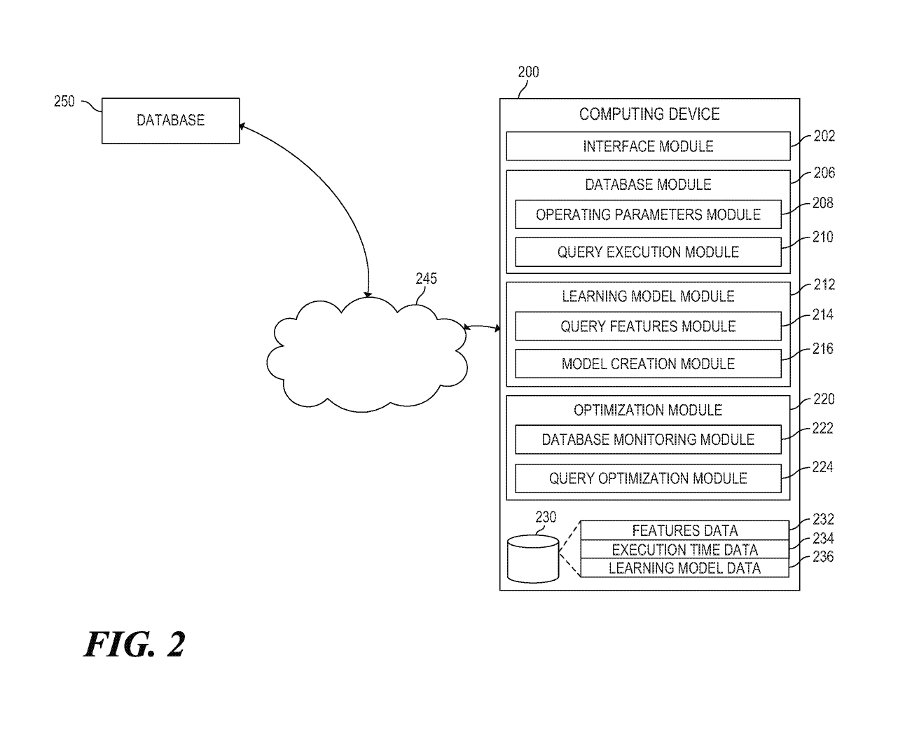

Referring now to the drawings, FIG. 1 is a block diagram of an example computing device 100 for predicting execution times of concurrent queries. Computing device 100 may be any computing device (e.g., database server, desktop computer, laptop computer, tablet device, etc.) with access to a database, such as database 250 of FIG. 2. In the embodiment of FIG. 1, computing device 100 includes a processor 110, an interface 115, and a machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126 to predict execution times of concurrent queries, as described below. As an alternative or in addition to retrieving and executing instructions, processor 110 may include one or more electronic circuits comprising a number of electronic components for performing the functionality of one or more of instructions 122, 124, 126.

Interface 115 may include a number of electronic components for communicating with a database. For example, interface 115 may be an Ethernet interface, a Universal Serial Bus (USB) interface, an IEEE 1394 (Firewire) interface, an external Serial Advanced Technology Attachment (eSATA) interface, or any other physical connection interface suitable for communication with the database. Alternatively, interface 115 may be a wireless interface, such as a wireless local area network (WLAN) interface or a near-field communication (NFC) interface. In operation, as detailed below, interface 115 may be used to send and receive data, such as features data and execution time data, to and from a corresponding interface of a database.

Machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for predicting execution times of concurrent queries.

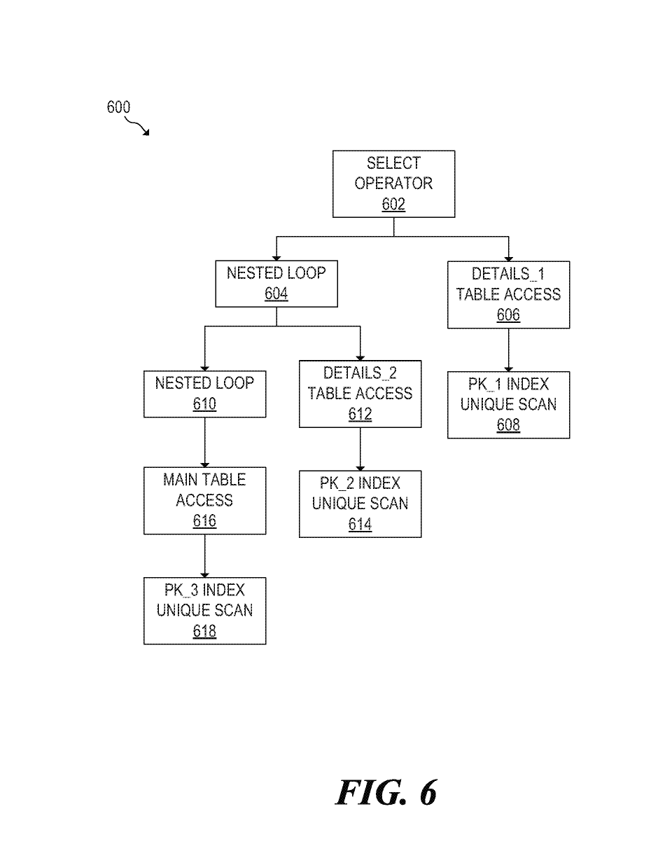

Historic data obtaining instructions 122 analyze the execution of concurrent queries to obtain historic data. For example, training concurrent queries are iteratively executed at varying concurrency levels to obtain the historic data. In this example, the concurrency level may varied by setting the MPL variable of a DBMS, which controls the maximum number of concurrently executing queries. During the execution of the concurrent queries, query features and query execution time may be monitored to obtain the historic data. The query features for a query may be extracted from a query execution plan of a concurrent query. A query execution plan is an ordered set of steps describing a SQL statement for accessing a DBMS and typically depicted in a hierarchical tree as described below with respect to FIG. 6. Query features may include, but are not limited to, a set of query operators, an amount of data for processing, etc.

Learning model creating instructions 124 create machine learning models based on the historic data described above. A machine learning model is capable of learning from training data, in this case historic data related to concurrent queries, and then generalizing the model to classify production data. Further, the machine learning model may continue to learn as production data is classified. In this example, the machine learning model is used to characterize a pending concurrent query based on the features of the concurrent query and the current concurrency level.

Execution schedule generating instructions 126 may use the machine learning model to schedule concurrent queries in a production environment. For example, a net of concurrent queries is analyzed and applied to the machine learning models to create an execution schedule for the concurrent queries. In this example, the execution schedule is generated based on the predicted execution time of each of the concurrent queries. The predicted execution time of a concurrent query may be determined based on its query features and the current concurrency level of the production environment. Specifically, the query features of the concurrent query and the concurrency level may be used to identify similar historic queries in the machine learning model, which are then used to determine the predicted execution time.

FIG. 2 is a block diagram of an example computing device 200 in communication via a network 245 with database 250. As illustrated in FIG. 2 and described below, computing device 200 may communicate with the database to predict execution times of concurrent queries.

As illustrated, computing device 200 may include a number of modules 202-224. Each of the modules may include a series of instructions encoded on a machine-readable storage medium and executable by a processor of the computing device 200. In addition or as an alternative, each module may include one or more hardware devices including electronic circuitry for implementing the functionality described below.

As with computing device 100 of FIG. 1, computing device 200 may be a server, a notebook, desktop, tablet, workstation, mobile device, or any other device suitable for executing the functionality described below. As detailed below, computing device 200 may include a series of modules 202-224 for enabling database analysis and validation.

Interface module 202 may manage communications with the database 250. Specifically, the interface module 202 may (1) initiate connections with the database and then send or receive features data 232 and execution time data 234 to/from the database.

Database module 206 may manage operation of the database 250. Although the components of database module 206 are described in detail below, additional details regarding an example implementation of module 206 are provided above in connection with instructions 122 of FIG. 1.

Operating parameters module 208 may configure and monitor operating parameters of the database 250. For example, operating parameters module 208 may set the concurrency level (i.e., MPL value) of the database 250. During the collection of historic data, operating parameters module 208 may iteratively adjust the concurrency level as concurrent queries are executed for training. Operating parameters module 208 may also manage other operating parameters including, but not limited to, system resources available to process queries (e.g., amount of memory available, number of processing units,), maximum number of available locks, whether debugging and/or logs are enabled, etc.

Query execution module 210 may execute concurrent queries in database 250. During execution, query execution module 210 may monitor the execution time of the queries, which may be stored as execution time data 234. Query execution module 210 may execute (1) concurrent queries during a training phase to obtain historic data and (2) production concurrent queries for a database in production.

Learning model module 212 may create machine learning models based on historic data. Although the components of learning model module 212 are described in detail below, additional details regarding an example implementation of module 212 are provided above in connection with instructions 124 of FIG. 1.

Query features module 214 may extract query queryfeatures from query execution plans of concurrent queries. Specifically, query features module 214 may obtain a query execution plan from the database 250 and then use the query execution plan to determine the query features (e.g., query operators, amount of data being processed, etc.).

Model creation model 216 may generate machine learning models based on the concurrency levels set by the operating parameters module 208, the execution times determined by the query execution module 210, and the query features extracted by the query features module 214 (collectively referred to as historic data). For example, a machine learning model is generated after the historic data is collected for a set of training queries. In this example, the set of training queries are iteratively executed at varying concurrency levels so that historic data can be collected at each of the concurrency levels. The machine learning model may then be used to predict the query execution times of production queries based on the query features of the production queries and the concurrency level of the DBMS.

Optimization module 220 may optimize the execution of production queries. Although the components of optimization module 220 are described in detail below, additional details regarding an example implementation of module 220 are provided above in connection with instructions 126 of FIG. 1.

Database monitoring module 222 may monitor database 250 for concurrent queries. As concurrent queries are initiated on the database 250, database monitoring module 222 may detect the concurrent queries and group them into sets for processing by query optimization module 224.

Query optimization module 224 may use machine learning models to generate query schedules for concurrent queries. A query schedule may specify an order for executing the concurrent queries, where the order is determined by the predicted query execution times of each of the concurrent queries. The query scheduled may also be generated such that the service level agreement (SLA's) of each of the concurrent queries is satisfied. An SLA may specify requirements for performance and reliability for a specific application. In this case, concurrent queries originating from the specific application are associated with the SLA. For example, an SLA may specify query capabilities (i.e., authorized query operators and targets) and performance requirements (i.e., time threshold for completing a query).

Storage device 230 may be any hardware storage device for maintaining data accessible to computing device 200. For example, storage device 230 may include one or more hard disk drives, solid state drives, tape drives, and/or any other storage devices. The storage devices may be located in computing device 200 and/or in another device in communication with computing device 200. As detailed above, storage device 230 may maintain features data 232, execution time data 234, and learning model data 236.

Database 250 may he any database accessible to computing device 200 over the network 245 that is suitable for providing database content. Database 250 may provide database content as data tables, data views, stored procedures, indexes, sequences, etc.

FIG. 3 is a flowchart of an example method 300 for execution by a computing device 100 for predicting execution times of concurrent queries. Although execution of method 300 is described below with reference to computing device 100 of FIG. 1, other suitable devices for execution of method 300 may be used, such as computing device 200 of FIG. 2. Method 300 may be implemented in the form of executable instructions stored on a machine-readable storage medium, such as storage medium 120, and/or in the form of electronic circuitry.

Method 300 may start in block 305 and continue to block 310, where computing device 100 obtains historic data by iteratively executing concurrent queries at varying concurrency levels. For example, training queries are executed at each of a range of concurrency levels (e.g., MPL values of 1, 2, 4, 8, 12, 16, 20, 24, 32). In this example as the training queries are executed, execution times and query features are collected for each of the executions.

In block 315, computing device 100 creates a machine learning model based on the historic data. The machine learning model is configured to predict execution times for a concurrent query based on its query features and the current concurrency level of the DBMS. In block 320, the machine learning model is used to generate an execution schedule fora set of concurrent queries. Specifically, the machine learning model is applied to each of the concurrent queries to determine a predicted execution time. Next, the predicted execution times is used to schedule the concurrent queries such that their associated service level agreements are satisfied. Method 300 may then continue to block 325, where method 300 may stop.

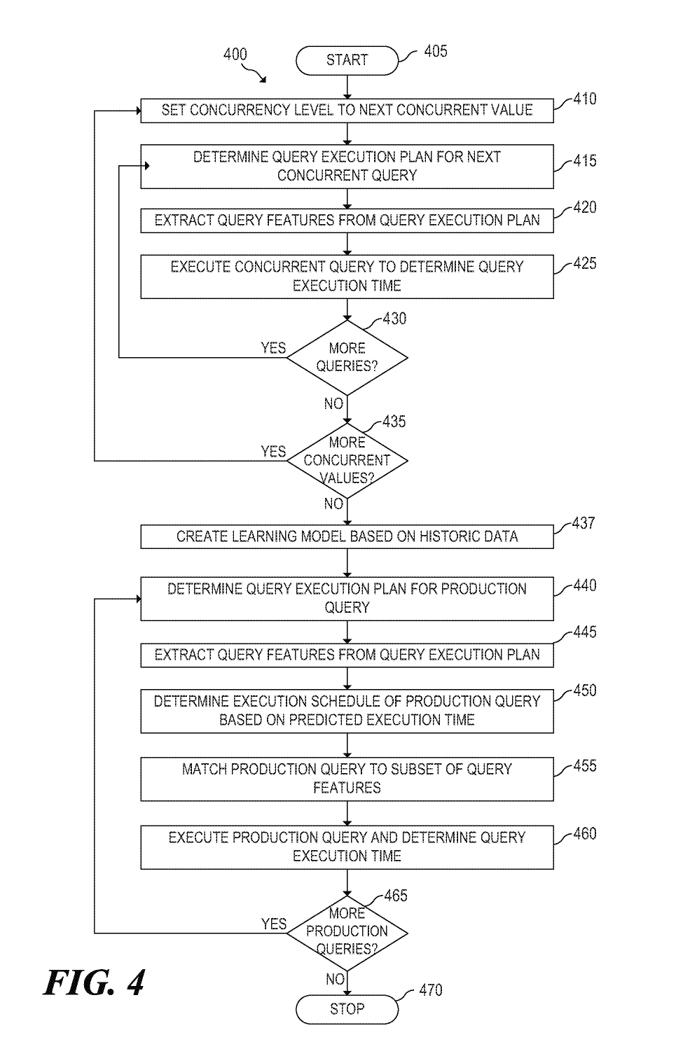

FIG. 4 is a flowchart of an example method 400 for execution by a computing device 100 for generating historic data and then predicting execution times of concurrent queries in production. Although execution of method 400 is described below with reference to computing device 100 of FIG. 1, other suitable devices for execution of method 400 may be used, such as computing device 200 of FIG. 2. Method 400 may be implemented in the form of executable instructions stored on a machine-readable storage medium, such as storage medium 120, and/or in the form of electronic circuitry.

Method 400 may start in block 405 and continue to block 410, where computing device 100 may set the concurrency level of a DBMS to the next concurrent value in a range of values. For example, the concurrency level may be the MPL parameter of the DBMS. In block 415, a query execution plan is determined for the pending concurrent query. The query execution plan is obtained from the DBMS.

In block 420, query features for the pending concurrent query are extracted from the query execution plan. For example, a set of query operators and an amount of data being processed is extracted from the plan. In block 425, the pending concurrent query is executed at the current concurrency level to determine the query execution time of the query. The concurrent query is executed simultaneously with other concurrent queries to simulate operating conditions.

In block 430, computing device 100 determines if there are more concurrent queries to execute. If there are more concurrent queries, method 400 returns to block 415, where the next concurrent query is processed. If there are no more concurrent queries, computing device 100 determines if there are more concurrent values in the range of concurrent values in block 435. If there are more concurrent values, method 400 returns to block 410 to process the next concurrent value in the range of values. The entire set of concurrent queries is executed at each of the concurrent values so that historic data can be collected at each of the concurrency levels.

If there are no more concurrent values in the range of values, method 400 may change from the training phase described above to a production phase. The collected historic data is used to create a machine learning model as described above at the end of the training phase in block 437. In block 440, a query execution plan is determined for the production query. In block 445, query features for the production query are extracted from the query execution plan.

In block 450, the extracted features from the production query are used to probe the machine learning model created in the training phase. The extracted query features are used to identify characteristics of related training queries represented in the machine learning model with one or more similar features. In block 455 the machine learning model is used to predict an execution time for the production query, which is then used to determine an execution schedule for the production query. Multiple production queries may be processed simultaneously on that an execution schedule for all the queries are created so that the queries' execution times can satisfy their service level agreements (i.e., time threshold for satisfying a query) during execution.

In block 460, the production query is executed according to the execution plan, and the query execution time of the query is determined. The machine learning model is updated to incorporate the query features and execution time determined during the execution of the production query. In block 465, computing device 465 determines if there are more production queries to execute. If there are more production queries to execute, method 400 returns to block 440, where the next production query is processed. If there are no more queries to execute, method 400 proceeds to block 470, where method 400 may stop.

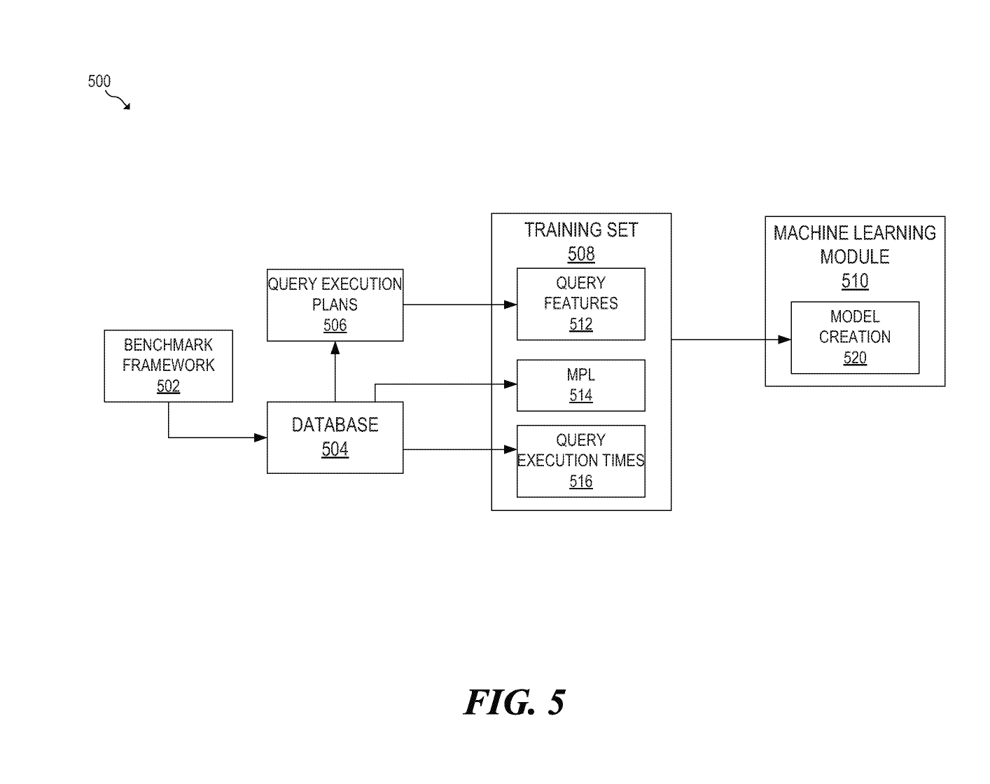

FIG. 5 is a flowchart of an example workflow 500 for creating a machine learning model for predicting execution times of concurrent queries. Benchmark framework 502 is used to monitor database 504 to determine query execution times 516. For example, training queries based on the Transaction Processing Council—Decision Support (TPC-DS) benchmark may be loaded and used to obtain the query execution times 516. In this example, the TPC-DS benchmark includes 100 different SQL queries over a set of relational database tables that model a retail sales enterprise. Within a TPC-DS workload, queries are initiated in a random order. The TPC-DS benchmark also includes a data generator to create database tables of various sizes.

For each TPC-DS workload, each query may be run in isolation and then at each concurrency level in a range of concurrency levels (e.g., MPL values of 1, 2, 4, 8, 12, 16, 20, 24, 32). For example, at an MPL value of 2 the workload may be divided in two parts and provided to two clients that each execute their portion of the workload concurrently, where the execution time of each query is measured. As MPL increases, resource contention increases and, generally, execution time increased. Because queries are randomly ordered, each time an individual query is executed, the query competes for resources with a different collection of queries.

Query execution plans 506 are extracted from the queries executed in database 504 to determine query features 512. The query execution plans 506 are provided by DBMS packages that generate textual or graphical representations of queries. In this case, sets of static features are extracted from the query execution plans such as the number and types of operators used (e.g., Sort, IO, Group By, Union, Join, Hash Join, Merge Join, Analytical, etc.). The query execution plans may also be parsed for further information as discussed below with respect to FIG. 6.

MPL parameter 514 may be obtained from the database. Again, a DBMS package is consulted to manage the value of the MPL parameter as each of the workloads is processed through database 504. After the training phase of the workflow is complete, training set 508 includes query features 512, MPL parameter 514, and query execution times 516, which may be collected as described above with respect to FIGS. 3 and 4.

At this stage, training set is used by model learning module 510 to generate a machine learning model 520. For example, a boosted trees technique may be used to form a group of decision trees based on this historic data. In this example, let yᵢₜ denote the elapsed time when the i-th query is executed in an environment with MPL=t, and sᵢdenote the extracted feature vector for query i. A varying-coefficient linear model may be used where the runtime for each query is assumed to increase linearly with MPL and both the intercept and slope of this linear relationship depend on query features. Mathematically, we assume that:

yᵢₜ=β₀(sᵢ)+β₁(sᵢ)t+εᵢₜ, (1)

which is estimated by boosted varying-coefficient trees. The model represented in equation (1) is trained in an offline mode with historic data. For a new query with feature vector s₀, we first predict β₀(s₀) and β1(s₀) using the trained model and then characterize the elapsed time as a linear function of MPL with intercept β₀(s₀) and slope β₁(s₀). The varying-coefficient linear model allows the execution time of a query to be predicted under any MPL number. The boosted trees technique automatically identifies the most statistically significant features. Rarely used features are weighted accordingly to decrease the occurrence of over-featured models.

Query execution time may also be predicted when the query is run in isolation. In this case, the MPL value is 1 and a nonparametric regression model is assumed,

yᵢ₁=β(sᵢ)+ηᵢₜ. (2)

The regression function β(sᵢ) may again be approximated by boosted trees. The technique described above is merely an example and other suitable techniques may be used to create prediction models (e.g., linear models, boosted stumps, support vector regression, etc.) for predicting execution times.

FIG. 6 is a diagram of an example query execution plan 600. In this example, query execution plan 600 is represented as a graphical, hierarchical tree of operators. The root node of the tree is a select operator 602 with child nodes nested loop 604 and details_1 table access 606. Each of nested loop 604 and 610 may represent a join operator with varying characteristics (e.g., inner join, outer join, hash join, etc.). Each of the table nodes 606, 612, and 616 may represent a table that is being joined in the select operator 602. Further, each of the table nodes 606, 612, and 616 has a child node representing the key scan 608, 614, and 618 performed to access data in the represented table.

Each node in query execution plan 600 represents a query feature that may be extracted. Further, characteristics of each of the query features may also be extracted from query execution plan 600. A textual portion of a query execution plan is parsed to obtain quantitative values for different operators such as listed below:
1. Number of occurrences: The total number of uses of the operator within the plan (e.g., the number of hash joins in the plan).
2. Total cost: Cumulative sum of cost over each occurrence of the operator.
3. Number of rows: Cumulative number of rows over each occurrence of the operator.
4. Total weighted cost: Weighted cost for an occurrence of operator is computed as the ratio of the cost of the operator to the number of nodes on which the operator was executed. Total weighted cost is then the cumulative sum of all the weighted cost for the operator.
5. Total weighted number of rows: Weighted number of rows for an occurrence of operator is computed as the ratio of number of rows processed by the operator to the number of nodes on which the operator was executed. Total weighted number of rows is then the cumulative sum of all the weighted number of rows for the operator.
   Besides the quantitative characterization of primary operators, additional quantitative metrics for the overall plan may be extracted such as listed below:

1. Number of Operations: Total number of operations in the plan.
2. Bushiness: Bushiness attempts to quantify the structure of the tree. It is obtained as the ratio of total number of operations to the maximum depth of the tree.
3. Total Cost: Cumulative sum of cost for the plan.
4. Total Rows: Cumulative number of rows processed by the plan.
   The features extracted from the query execution plan are referred to as static features. In addition to the extracted static features, the execution time of the query and the concurrency level of the runtime environment are also recorded.

The set of extracted features for these historic queries form a training data set for the construction of a machine learning model. In some cases, the set of runtime features can be further extended with available DBMS measurements.

The foregoing disclosure describes a number of example embodiments for predicting execution times of concurrent queries. In this manner, the embodiments disclosed herein enable a benchmarking approach combined with an advanced machine learning technique for predicting query execution times in a runtime environment with concurrent queries. The machine learning model accurately predicts the query execution time as a function of multiple concurrent queries because the model is able to estimate the query execution times under varying concurrency levels.

1. A system for predicting execution times of concurrent queries, the system comprising of:
a processor to:
iteratively generate historic data for creating a machine learning model by:
varying a concurrency level of query executions in a database;
determining a query execution plan for a pending concurrent query;
extracting a plurality of query features from the query execution plan; and
executing the pending concurrent query to determine a query execution time;
create the machine learning model based on the plurality of query features, variation in the concurrency level, and the query execution time; and
use the machine learning model to generate an execution schedule for a plurality of production queries, wherein the execution schedule satisfies service level agreements of the plurality of production queries.

2. The system of claim 1, wherein the processor uses the machine learning model to generate the execution schedule for the plurality of production queries by:
matching one of the plurality of production queries to a subset to the plurality of query features;
determining a predicted execution time for the one of the plurality of production queries based on the subset; and
determining an execution order for the plurality of production queries based on the predicted execution time.

3. The system of claim 2, wherein the processor is further to:
identify significant features of the plurality of features that are statistically used more often in production, wherein the subset includes the significant features.

4. The system of claim 1, wherein the processor is further to:
determine a production query execution plan for each of the plurality of production queries;
extract a plurality of production query features from each of the production query execution plan;
execute each of the plurality of production queries to determine a production query execution time;
update the machine learning model based on the plurality of production query features and the production query execution time of each of the plurality of production queries.

5. The system of claim 1, wherein the concurrency level is in a range of two to a maximum value greater than two, wherein each value in the range is iteratively used as the concurrency level to generate the historic data.

6. The system of claim 1, wherein the machine learning model is created using a boosted trees technique that generates a group of decision trees based on the plurality of query features, variation in the concurrency level, and the query execution time.

7. A method for predicting execution times of concurrent querues, comprising:
receiving historic data associated with a database for creating a machine learning model, wherein the historic data includes query execution times for training queries that have been iteratively executed at varying concurrency levels and a plurality of query features that have been extracted from query execution plans of the training queries;
using a boosted trees technique to create the machine learning model based on the plurality of query features, the varying concurrency levels, and the query execution times; and
using the machine learning model to generate an execution schedule for a plurality of production queries, wherein the execution schedule satisfies service level agreements of the plurality of production queries.

8. The method of claim 7, wherein using the machine learning model to generate the execution schedule for the plurality of production queries comprises:
matching one of the plurality of production queries to a subset of the plurality of query features;
determining a predicted execution time for the one of the plurality of production queries based on the subset; and
determining an execution order for the plurality of production queries based on the predicted execution time.

9. The method of claim 8, further comprising:
identifying significant features of the plurality of features that are statistically used more often in production, wherein the subset includes the significant features.

10. The method of claim 7, further comprising:
determining a production query execution plan for each of the plurality of production queries;
extracting a plurality of production query features from each of the production query execution plan;
executing each of the plurality of production queries to determine a production query execution time;
updating the machine learning model based on the plurality of production query features and the production query execution time of each of the plurality of production queries.

11. The method of claim 7, wherein the varying concurrency levels are in a range of two to a maximum value greater than two, wherein each value in the range has been iteratively used to generate the historic data.

12. A non-transitory machine-readable storage medium encoded with instructions executable by a processor for predicting execution times of concurrent queries, the machine-readable storage medium comprising instructions to:
iteratively generate historic data for creating a machine learning model by:
varying a concurrency level of query executions in a database, wherein the concurrency level is iteratively varied to values in a range of two to a maximum value greater than two;
determining a query execution plan for pending concurrent query;
extracting a plurality of query features from the query execution plan; and
executing the pending concurrent query to determine a query execution time;
create the machine learning model based on the plurality of query features, variation in the concurrency level, and the query execution time; and
use the machine learning model to generate an execution schedule for a plurality of production queries, wherein the execution schedule satisfies service level agreements of the plurality of production queries.

13. The non-transitory machine-readable storage medium of claim 12, wherein using the machine learning model to generate the execution schedule for the plurality of production queries comprises:
matching one of the plurality of production queries to a subset of the plurality of query features;
determining a predicted execution time for the one of the pluralityy of production queries based on the subset; and
determining an execution order for the plurality of production queries based on the predicted execution time.

14. The non-transitory machine-readable storage medium of claim 13, further comprising instructions to:
identify significant features of the plurality of features that are statistically used more often in production, wherein the subset includes the significant features.

15. The non-transitory machine-readable storage medium of claim 12, further comprising instructions to:
determine a production query execution plan for each of the plurality of production queries;
extract a plurality of production query features from each of the production query execution plan;
execute each of the plurality of production queries to determine a production query execution time;
update the machine learning model based on the plurality of production query features and the production query execution time of each of the plurality of production queries.
